(19) United States
(12) Patent Application Publication
(10) Pub. No.: US 2020/0177976 A1
(43) Pub. Date: Jun. 4, 2020

(54) METHODS OF OPERATING AN ELECTRONIC DEVICE TO COMMUNICATE WITH AN ELECTRIC UTILITY METER OR A TRANSFORMER, AND RELATED ELECTRONIC DEVICES AND COMPUTER PROGRAM PRODUCTS

(71) Applicant: Duke Energy Corporation, Charlotte, NC (US)

(72) Inventors: Adam Anderson, Indian Trail, NC (US); Kirby Jackman, Chicago, IL (US); Jessica Sherman, Dallas, TX (US); Russell Howard, Easley, SC (US); Andrew DesRosiers, Charlotte, NC (US)

(21) Appl. No.: 16/697,563

(22) Filed: Nov. 27, 2019

Related U.S. Application Data
(60) Provisional application No. 62/772,718, filed on Nov. 29, 2018.

(51) Int. Cl. H04Q 9/00; H04L 29/08

(52) U.S. Cl. CPC H04Q 9/00; H04L 67/02; H04Q 2209/75; H04Q 2209/50; H04Q 2209/40

(57) ABSTRACT

Methods of operating an electronic device to communicate with an electric utility meter or a transformer are provided. A method of operating an electronic device to communicate with an electric utility meter or a transformer includes transmitting, via a cellular network and/or an unlicensed frequency band of a wireless mesh network, a ping from the electronic device to the electric utility meter or the transformer. The method includes receiving, via the cellular network and/or the unlicensed frequency band of the wireless mesh network, meter data from the electric utility meter or the transformer at the electronic device, in response to the ping. Moreover, the method includes displaying, via a Graphical User Interface (GUI) of the electronic device, an indication of an electrical parameter measured by the electric utility meter, in response to receiving the meter data. Related electronic devices and computer program products are also provided.

### CROSS-REFERENCE TO RELATED APPLICATION

The present application claims the benefit of U.S. Provisional Patent Application No. 62/772,718, filed Nov. 29, 2018, entitled Methods of Operating an Electronic Device to Communicate with an Electric Utility Meter, and Related Electronic Devices and Computer Program Products, the disclosure of which is hereby incorporated herein in its entirety by reference.

### FIELD

The present disclosure relates to communications methods and utility meters.

### BACKGROUND

Customers of an electric utility often contact their electric utility to report and check the status of outages. Some reported outages, however, are not actually outages. As a result, the electric utility may deploy a utility truck and then discover that deployment of the utility truck is unnecessary to address a reported issue. For example, a customer may report an outage despite only needing to flip a breaker. Unnecessary utility truck deployments may be time-consuming and costly for the electric utility, and may be a negative customer experience for customers.

### SUMMARY

A method of operating an electronic device to communicate with an electric utility meter or a transformer, according to some embodiments herein, may include transmitting, via a cellular network and/or an unlicensed frequency band of a wireless mesh network, a ping from the electronic device to the electric utility meter or the transformer. The method may include receiving, via the cellular network and/or the unlicensed frequency band of the wireless mesh network, meter data from the electric utility meter or the transformer at the electronic device, in response to the ping. Moreover, the method may include displaying, via a Graphical User Interface (GUI) of the electronic device, an indication of a voltage measured by the electric utility meter, in response to receiving the meter data.

In some embodiments, displaying the indication of the voltage may include displaying an indication that the voltage is present on a customer side of the electric utility meter. Additionally or alternatively, displaying the indication of the voltage may include displaying a numerical value of an average voltage measured by the electric utility meter.

According to some embodiments, the method may include receiving, via the GUI, a first user input including a meter identifier of the electric utility meter or a transformer identifier of the transformer. Transmitting the ping may be performed in response to a second user input that is received via the GUI after receiving the first user input. In some embodiments, the first and second user inputs may be user inputs to a website that is behind a firewall of an electric utility. Moreover, the method may include accessing the website via a custom web browser of the electric utility. Additionally or alternatively, the method may include receiving, via the GUI, a third user input to re-ping the electric utility meter or to delete the electric utility meter from a list of pinged electric utility meters, after displaying the indication of the voltage. The list of the pinged electric utility meters may include respective indications of average voltage measured by the pinged electric utility meters.

In some embodiments, transmitting the ping and receiving the meter data may be performed concurrently with a telephone or web-based communication session between a user of the electronic device and an electric utility customer who is associated with the electric utility meter. Additionally or alternatively, the unlicensed frequency band of the wireless mesh network may include 900 Megahertz (MHz).

According to some embodiments, the electric utility meter may be an Advanced Metering Infrastructure (AMI) meter. Moreover, the method may include displaying, via the GUI, an indication of an error in response to a user input, via the GUI, that includes: an invalid meter number; or a meter number of a non-AMI meter.

In some embodiments, the meter data may include real-time data including: an instantaneous voltage measured by the electric utility meter; instantaneous power delivered to a customer premise that is connected to the electric utility meter; instantaneous power received from the customer premise; accumulated power delivered to the customer premise; and accumulated power received from the customer premise. Moreover, the method may include displaying, via the GUI, the real-time data, in response to a user input after displaying the indication of the voltage.

According to some embodiments, the method may include displaying, via the GUI, an indication of a connection status of a switch of the electric utility meter. Moreover, the method may include transmitting, via the cellular network and/or the unlicensed frequency band of the wireless mesh network, a command that remotely controls the switch to connect or disconnect the electric utility meter, in response to a user input via the GUI.

In some embodiments, the method may include receiving, via the cellular network and/or the unlicensed frequency band of the wireless mesh network, an unsolicited indication from another electric utility meter that the other electric utility meter is experiencing a power outage. Additionally or alternatively, transmitting the ping may include transmitting the ping via a Local Area Network (LAN) of an electric utility to the cellular network or the wireless mesh network, and receiving the meter data may include receiving the meter data via the LAN from the cellular network or the wireless mesh network.

According to some embodiments, transmitting the ping may include: transmitting, via the cellular network, the ping from the electronic device to a gateway device that is in the field; then transmitting, via the unlicensed frequency band, the ping from the gateway device to the electric utility meter or the transformer. Moreover receiving the meter data may include: receiving, via the unlicensed frequency band, the meter data from the electric utility meter or the transformer at the gateway device; then receiving, via the cellular network, the meter data from the gateway device at the electronic device.

An electronic device, according to some embodiments herein, may include a display screen, a network interface, and a processor. Moreover, the electronic device may include a storage medium coupled to the processor and including computer readable program code that when executed by the processor causes the processor to perform operations including transmitting, via a cellular network and/or an unlicensed frequency band of a wireless mesh network, a ping from the electronic device to an electric utility meter or a transformer. The operations may include receiving, via the cellular network and/or the unlicensed frequency band of the wireless mesh network, meter data from the electric utility meter or the transformer at the electronic device, in response to the ping. Moreover, the operations may include displaying, via the display screen, an indication of a voltage measured by the electric utility meter, in response to receiving the meter data.

In some embodiments, the network interface may be configured to connect the electronic device to a LAN of an electric utility. Moreover, transmitting the ping may include using the network interface to transmit the ping via the LAN to the cellular network or the wireless mesh network, and receiving the meter data may include using the network interface to receive the meter data via the LAN from the cellular network or the wireless mesh network.

A computer program product, according to some embodiments herein, may include a non-transitory computer readable storage medium including computer readable program code therein that when executed by a processor causes the processor to perform operations including transmitting, via a cellular network and/or an unlicensed frequency band of a wireless mesh network, a ping from an electronic device to an electric utility meter or a transformer. The operations may include receiving, via the cellular network and/or the unlicensed frequency band of the wireless mesh network, meter data from the electric utility meter or the transformer at the electronic device, in response to the ping. Moreover, the operations may include displaying, via a GUI of the electronic device, an indication of an electrical parameter measured by the electric utility meter, in response to receiving the meter data.

In some embodiments, displaying the indication of the electrical parameter may include: displaying an indication that a voltage is present on a customer side of the electric utility meter; and/or displaying a numerical value of an average voltage measured by the electric utility meter.

### BRIEF DESCRIPTION OF THE DRAWINGS

FIG. 1A is a schematic illustration of an electric utility meter that is at or adjacent a premise of a customer of an electric utility, according to various embodiments.

FIG. 1B is a schematic illustration of a room of an office (or data center) of an electric utility, according to embodiments of the present inventive concepts.

FIG. 1C is a schematic illustration of an electronic device that is used by a line technician in the field, according to embodiments of the present inventive concepts.

FIG. 2A is a block diagram of an electronic device that is configured to communicate with an electric utility meter, according to embodiments of the present inventive concepts.

FIG. 2B is a block diagram of an electric utility meter that is configured to communicate with an electronic device, according to embodiments of the present inventive concepts.

FIG. 2C is a block diagram that illustrates details of an example processor and memory that may be used in accordance with various embodiments.

FIGS. 3A to 3F are flowcharts of operations at an electronic device for communicating with an electric utility meter (or a transformer), according to embodiments of the present inventive concepts.

FIGS. 4A to 4E are screenshots of a Graphical User Interface (GUI) of an electronic device that is configured to communicate with an electric utility meter (or a transformer), according to embodiments of the present inventive concepts.

### DETAILED DESCRIPTION

Pursuant to embodiments of the present inventive concepts, methods of operating an electronic device to communicate with an electric utility meter are provided. Conventional operations of pinging the meter to receive a binary response may provide insufficient data to troubleshoot a reported customer problem. Moreover, some conventional meter ping operations are too slow to provide efficient customer support. The methods of the present inventive concepts, however, may be used to rapidly obtain various data from the meter to enable an electric utility to remotely troubleshoot a reported customer problem before deploying a utility truck. For example, the data may include a meter read, connection status, an instantaneous voltage, an average voltage, delivered power usage, and/or received power usage.

As an example, a meter may be receiving low-voltage power, which may result in a customer experiencing flickering lights, the customer's lights being dim, or the customer's appliance (e.g., a clothes dryer) not functioning properly. Merely pinging the meter to receive a binary response, such as “yes” or “no,” may not identify the low voltage, and thus may result in unnecessarily sending a utility truck to the customer. The methods of the present inventive concepts, however, may rapidly provide voltage data that the electric utility can use to identify the low voltage and better assess and correct the situation.

Example embodiments of the present inventive concepts will be described in greater detail with reference to the attached figures.

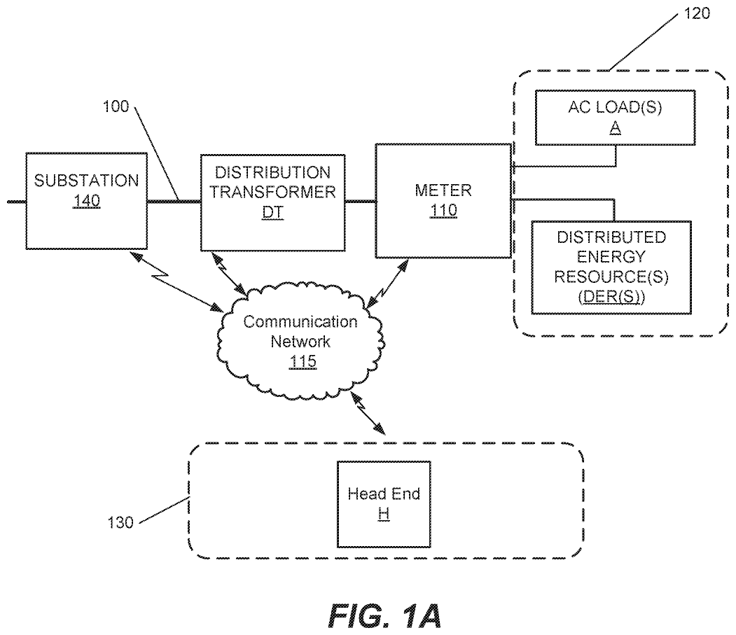

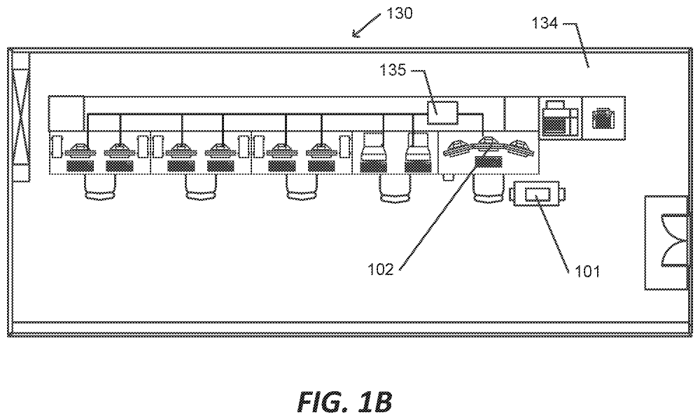

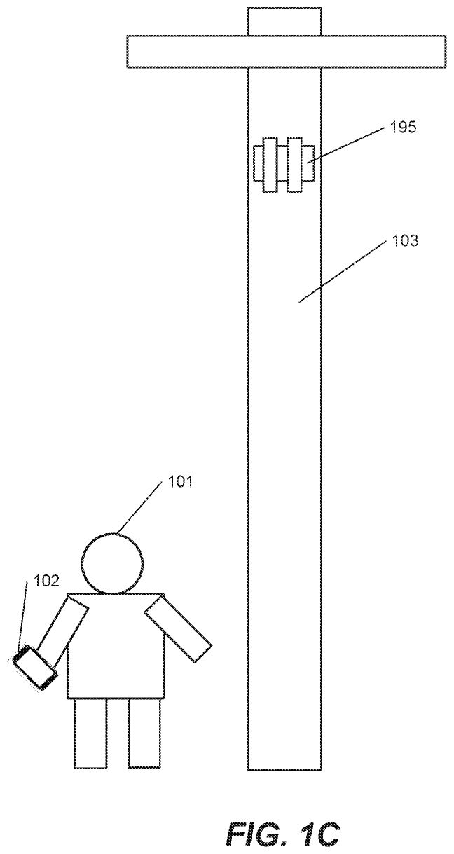

FIG. 1A is a schematic illustration of an electric utility meter 110 that is at or adjacent a premise 120 of a customer of an electric utility, according to various embodiments. For example, the customer premise 120 may be a house, apartment, office, or other building, location, or structure, for which the meter 110 can be provided for the customer. A customer premise 120 may thus be a structure such as a billboard, as well as a home or a business. Accordingly, the term “premise,” as used herein, may be interchangeable with the term “premises,” in that either term may be used herein to refer to a building, part of a building, or other structure for which the meter 110 may be provided.

The meter 110 may be configured to interface with one or more distributed energy resources DER at the customer premise 120. For example, the meter 110 may be configured to interface with a solar photovoltaic (PV) system, a fuel cell, an energy storage system, or an Electric Vehicle (EV) charging station.

The meter 110 may provide electricity from an electric grid 100 to at least one Alternating Current (AC) load A that is at the customer premise 120, and may measure electricity usage at the customer premise 120. For example, the AC load(s) A may include at least one appliance that may be powered by the electric grid 100 through the meter 110. An appliance may be a refrigerator, dishwasher, laundry machine, oven, or any other large machine that uses electricity to perform, for example, cooking, cleaning, or food preservation functions in a household, institutional, commercial, or industrial setting.

Additionally or alternatively to appliances, the AC load(s) A may include various devices that use electricity and are connected to the meter 110. For example, consumer electronics and heating/cooling devices and/or systems may be at the customer premise 120. Moreover, in some embodiments, the customer premise 120 may be a billboard, and the electric grid 100 may provide power for lights or an electronic display of the billboard.

The meter 110 is downstream from an electric utility substation 140 that serves the customer premise 120. The substation 140 may include one or more transformers. Between the substation 140 and the meter 110 is a distribution transformer DT, which may control a voltage level of power that is transmitted to the meter 110. In particular, the distribution transformer DT serves the customer premise 120 and may be the closest transformer of the electric grid 100 to the customer premise 120. The distribution transformer DT may be underground, mounted on a concrete pad, mounted on a utility pole, or otherwise fixed at a location that is upstream and spaced apart from the meter 110.

A single distribution transformer DT may provide power to one or more customers in a given area. For example, in an urban area, a plurality of homes may be fed off of a single distribution transformer DT. Rural distribution, on the other hand, may use one distribution transformer DT per customer. Moreover, a large commercial or industrial complex may rely on multiple distribution transformers DT.

A distribution transformer DT has a low-voltage secondary (e.g., output) side that distributes power to one or more customers. For example, in the United States, the low-voltage secondary side of the distribution transformer DT may be configured for a 240/120-Volt system, and three wires (including one neutral wire) may be fed from the low-voltage secondary side to the meter 110.

The meter 110 (or the distribution transformer DT) may be communicatively coupled to an office/data center 130 of an electric utility via a communication network 115. For example, the communication network 115 may comprise a wireless network, such as a cellular (e.g., 3G/4G/5G/LTE, other cellular) network and/or a wireless mesh network. Accordingly, the meter 110 (or the distribution transformer DT) may communicate wirelessly with the office/data center 130, which may comprise a head end H of the electric utility, via the communication network 115. Additionally or alternatively, the meter 110 (or the distribution transformer DT) may communicate wirelessly, via the communication network 115, with a handheld portable electronic device 102 that is in the field (FIG. 1C).

FIG. 1B is a schematic illustration of a room 134 of an office/data center 130 of an electric utility, according to embodiments of the present inventive concepts. The room 134 may include one or more electronic devices 102 that may communicate with an electric utility meter 110 (FIG. 1A) via a communication network 115 (FIG. 1A). For example, a user 101, such as an electric utility employee or contractor, may provide user inputs to an electronic device 102 to communicate with the meter 110 or with a distribution transformer DT (FIG. 1A) to which the meter 110 is coupled. The electronic device 102 may be connected to a Local Area Network (LAN) 135 of the electric utility. In some embodiments, the LAN 135 may comprise a wired and/or wireless (e.g., Wi-Fi) Ethernet network that connects a plurality of electronic devices 102 that are inside the office/data center 130 to each other and/or to the communication network 115 (FIG. 1A). The electronic devices 102 may comprise desktop computers, laptop computers, tablet computers, and/or smartphones.

One example of the room 134 is a control room, such as a Distribution Control Center (DCC), in which one or more users 101 may use the present inventive concepts for support in closing outage tickets and reducing truck rolls/deployment. Another example of the room 134 is a customer care center, in which one or more users 101 may use the present inventive concepts to support customer outage phone calls or power quality phone calls. For example, the customer care center may be a call center in which a plurality of users 101 are taking telephone calls from customers.

FIG. 1C is a schematic illustration of an electronic device 102 that is operated by a user 101, such as a line technician, in the field, according to embodiments of the present inventive concepts. For example, the user 101 may use the electronic device 102 to communicate via a communication network 115 (FIG. 1A) while the user 101 is on or adjacent a utility distribution pole 103. A line technician is not required, however, to be on or adjacent the utility distribution pole 103 to use the electronic device 102 according to embodiments of the present inventive concepts. Rather, the line technician may be anywhere in the field. As shown in FIG. 1C, the electronic device 102 may be a handheld portable electronic device, such as a smartphone or a tablet computer.

In some embodiments, a plurality of gateway devices 195 can be used in the field to collect data from a mesh network comprising electric utility meters 110 (FIG. 1A). The gateway devices 195 can backhaul the collected data to a head end H (FIG. 1A), or other back office system(s), of an electric utility via a cellular communications link of a communication network 115 (FIG. 1A), which may comprise a cellular and wireless mesh network. For example, each gateway device 195 may include a cellular transceiver that is configured to communicate with the head end H and a 900 Megahertz (MHz) mesh transceiver that is configured to communicate with the meters 110. Each gateway device 195 may be within a few hundred feet (or up to about one thousand feet) of a group of meters 110. As shown in FIG. 1C, a gateway device 195 may, in some embodiments, be attached to the utility distribution pole 103.

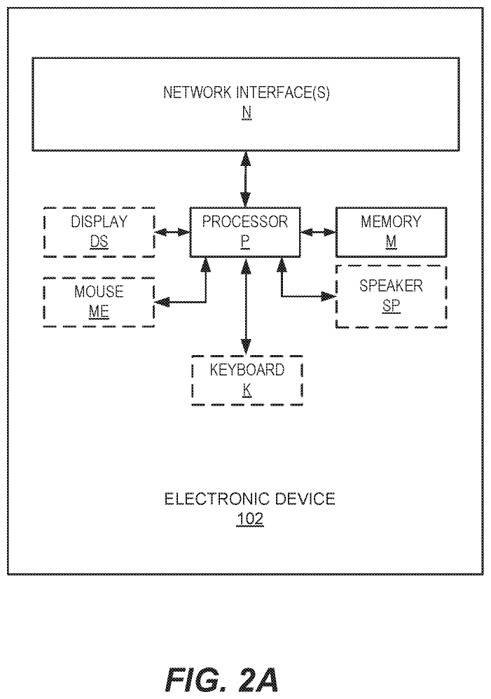

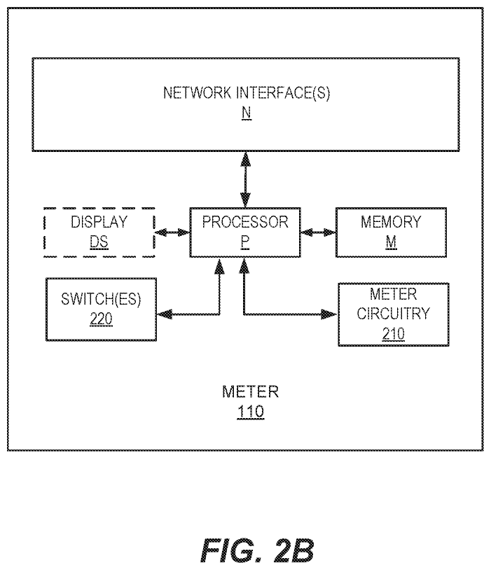

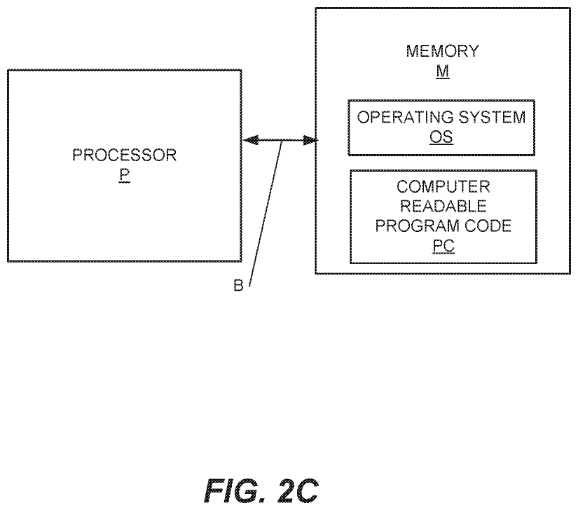

FIG. 2A is a block diagram of an electronic device 102 that is configured to communicate with an electric utility meter 110 (FIG. 1A), according to embodiments of the present inventive concepts. The electronic device 102 may include a processor P and a memory M. The electronic device 102 may also include network interface(s) N and input/output interface(s), such as a display screen DS, a mouse ME, a keyboard (or keypad) K, and/or a speaker SP. The input/output interface(s) may be configured to receive user inputs from a user 101 (FIGS. 1B and 1C) and/or to display data to the user 101. In some embodiments, the display screen DS may comprise a touchscreen display.

The processor P may be coupled to the network interface(s) N. The processor P may be configured to communicate with one or more electric utility meters 110 via the wireless network interface(s) N. For example, the network interface(s) N may include short-range wireless communications circuitry, such as Wi-Fi circuitry and/or BLUETOOTH® circuitry. Additionally or alternatively, the network interface(s) N may include cellular communication circuitry that provides a cellular wireless interface (e.g., 4G/5G/LTE, other cellular) and/or circuitry that provides a wireless mesh network interface. In some embodiments, the electronic device 102 may be a handheld portable electronic device that may be held by the user 101. Alternatively, the electronic device 102 may be a desktop computer or laptop computer. The network interface(s) N may include a wired and/or wireless network interface such as a wired and/or wireless LAN (e.g., Ethernet/Wi-Fi) interface by which the electronic device 102 may be configured to connect to a LAN of an electric utility, such as the LAN 135 (FIG. 1B). Accordingly, the electronic device 102 may communicate with the meter 110 via the wired and/or wireless LAN interface when the LAN of the electric utility is connected to a communication network 115 (FIG. 1A).

FIG. 2B is a block diagram of an electric utility meter 110 that is configured to communicate with an electronic device 102 (FIGS. 1B, 1C, and 2A), according to embodiments of the present inventive concepts. The electronic device 102 is operated by a user 101 (FIGS. 1B and 1C). Such communications may, in some embodiments, be routed through one or more devices (e.g., other electronic device(s) 102 and/or a gateway device 195 (FIG. 1C)) between the meter 110 and the electronic device 102 that is operated by the user 101.

In some embodiments, the meter 110 may be a smart meter, such as a single-phase or poly-phase Advanced Metering Infrastructure (AMI) meter. Accordingly, similar to the electronic device 102 of FIG. 2A, the meter 110 may include a processor P, a memory M, and network interface(s) N. The meter 110 also include meter circuitry 210 that is configured to measure one or more electrical parameters, such as voltage, power delivered to a customer premise 120 (FIG. 1A), and/or power received by an electric utility from the customer premise 120. In some embodiments, the meter 110 may further include a display screen DS, which may display one or more electrical parameters measured by the meter circuitry 210. Additionally or alternatively, the meter 110 may include one or more switches 220 that are configured to connect and/or disconnect power at the customer premise 120.

FIG. 2C is a block diagram that illustrates details of an example processor P and memory M that may be used in accordance with various embodiments. The processor P communicates with the memory M via an address/data bus B. The processor P may be, for example, a commercially available or custom microprocessor. Moreover, the processor P may include multiple processors. The memory M may be a non-transitory computer readable storage medium and may be representative of the overall hierarchy of memory devices containing the software and data used to implement various functions of an electronic device 102 as described herein. The memory M may include, but is not limited to, the following types of devices: cache, ROM, PROM, EPROM, EEPROM, flash, Static RAM (SRAM), and Dynamic RAM (DRAM).

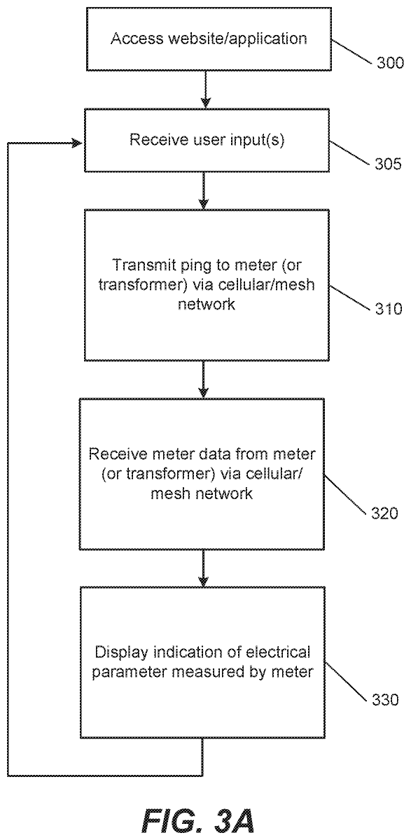

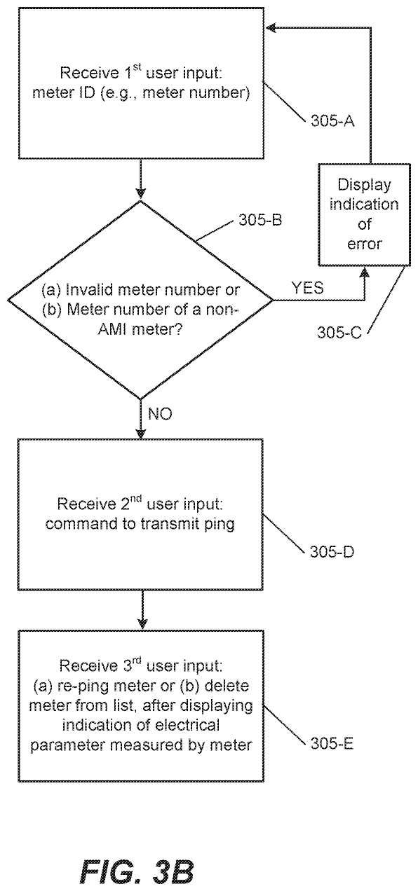

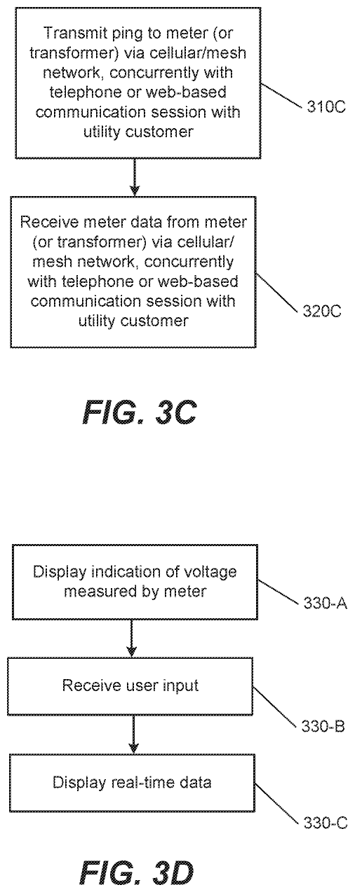

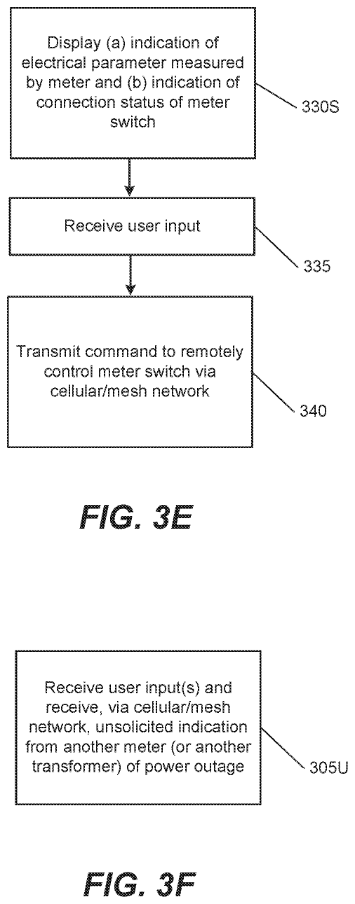

As shown in FIG. 2C, the memory M may hold various categories of software and data, such as computer readable program code PC and/or an operating system OS. The operating system OS controls operations of an electronic device 102 or an electric utility meter 110. In particular, the operating system OS may manage the resources of the electronic device 102 or the meter 110 and may coordinate execution of various programs by the processor P. For example, the computer readable program code PC, when executed by a processor P of the electronic device 102, may cause the processor P to perform any of the operations illustrated in the flowcharts of FIGS. 3A to 3F.

FIGS. 3A to 3F are flowcharts of operations at an electronic device 102 (FIGS. 1B, 1C, and 2A) for communicating with an electric utility meter 110 (FIGS. 1A and 2B) or a transformer (e.g., a distribution transformer DT (FIG. 1A)), according to embodiments of the present inventive concepts. Referring to FIG. 3A, operations at the electronic device 102 may include transmitting (Block 310) a ping from the electronic device 102 to the meter 110 (or the transformer) via a communication network 115 (FIG. 1A), which may comprise a Radio Frequency (RF) wireless communication network. For example, the ping may be transmitted via/using a cellular network and/or an unlicensed frequency band of a wireless mesh network. As an example, the ping may be transmitted from the electronic device 102 to a gateway device 195 (FIG. 1C) via a cellular communications link, and then transmitted from the gateway device 195 to the meter 110 (or the transformer) via the unlicensed frequency band.

The electronic device 102 may receive (Block 320), via/using the cellular network and/or the unlicensed frequency band of the wireless mesh network, meter data from the meter 110 (or the transformer), in response to the ping. As an example, the meter data may be received from the meter 110 (or the transformer) at the gateway device 195 via the unlicensed frequency band, and then received from the gateway device 195 at the electronic device 102 via the cellular communications link. The unlicensed frequency band may comprise 900 MHz. In some embodiments, the transmit (Block 310) and receive (Block 320) operations may be performed via the same medium/network, such as the same cellular network or the same wireless mesh network.

Moreover, the electronic device 102 may display (Block 330), via a GUI of the electronic device 102, an indication of an electrical parameter (e.g., a voltage) measured by the meter 110, in response to receiving (Block 320) the meter data. For example, the GUI may be displayed on a display screen DS (FIG. 2A) of the electronic device 102.

The cellular/mesh network may communicate the ping and the meter data relatively quickly. For example, the electronic device 102 may receive (Block 320) the meter data within 9-60 seconds of transmitting (Block 310) the ping. In comparison with such fast communications, some conventional techniques have may take 30-45 minutes, which may be too slow to efficiently provide real-time assistance to an electric utility customer. Moreover, conventional responses to pings may be not only slow but also simple binary responses, whereas the meter data received (Block 320) in FIG. 3A may include a plurality of measurements performed by the meter 110 and/or a plurality of status indications for the meter 110. A conventional binary response may be, for example, a “yes” or “no” response that indicates whether the meter 110 is capable of communicating.

Referring still to FIG. 3A, in some embodiments, the electronic device 102 may transmit (Block 310) the ping in response to receiving (Block 305) one or more user inputs at the electronic device 102. For example, a user 101 (FIGS. 1B and 1C) may operate the electronic device 102 to access (Block 300) a website (and/or an end-user software application) and may provide the user input(s) to the website/application to transmit (Block 310) the ping.

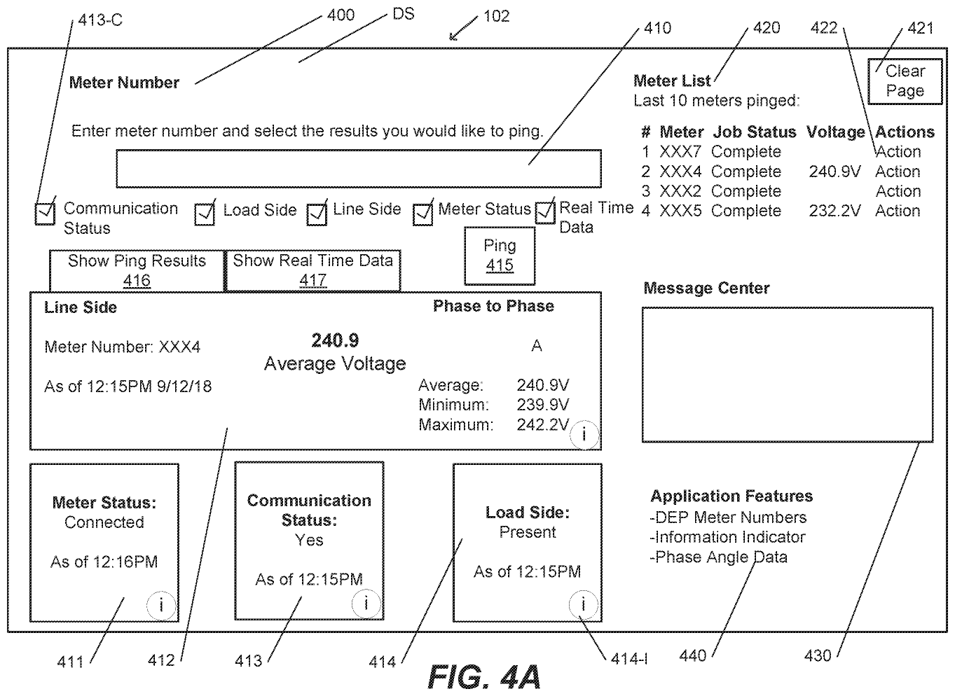

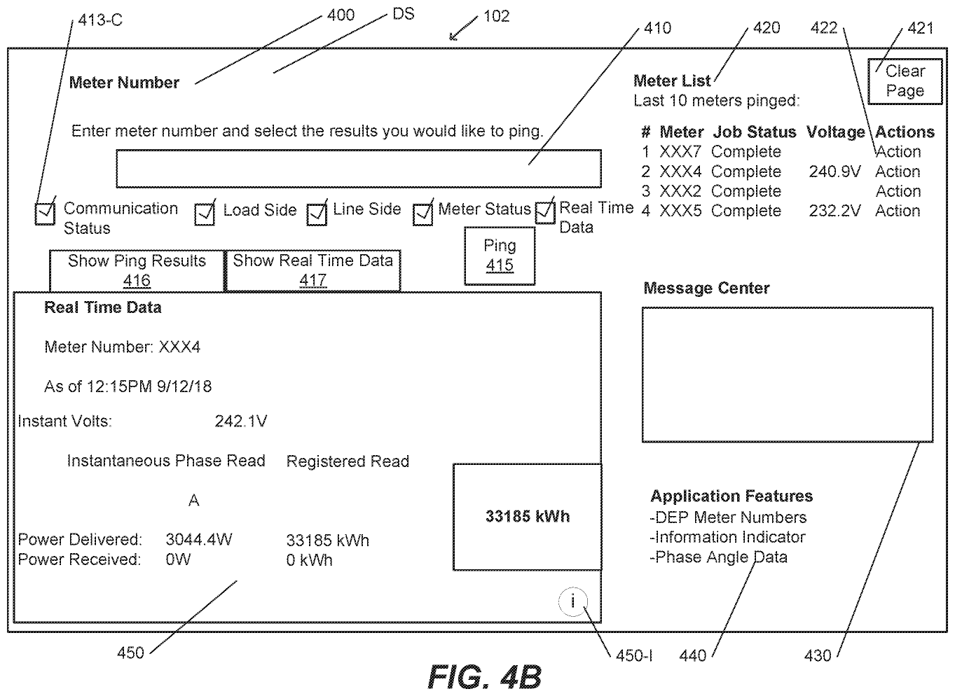

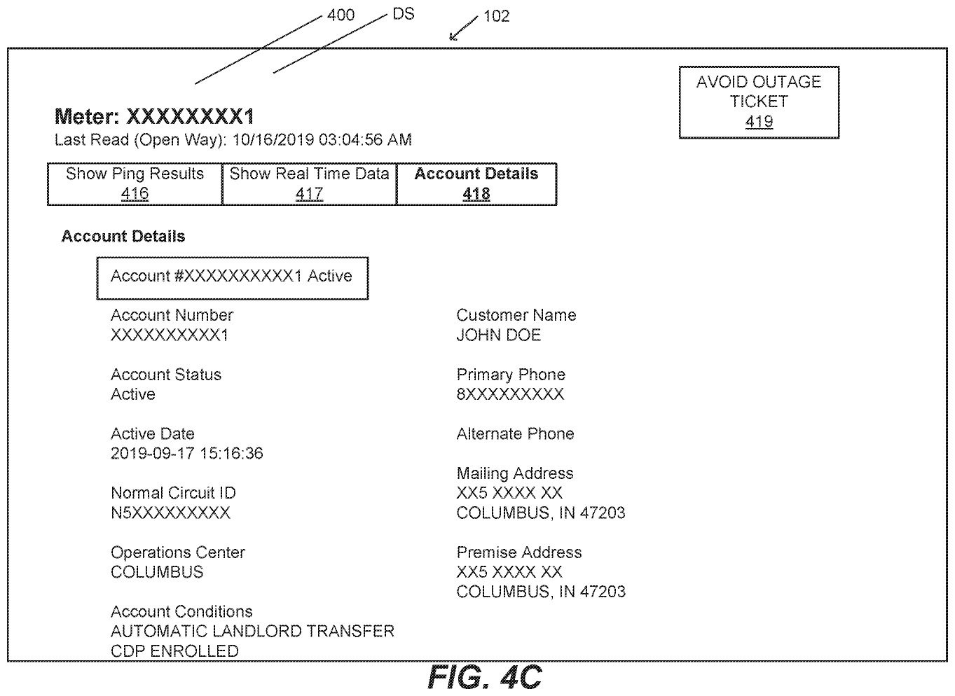

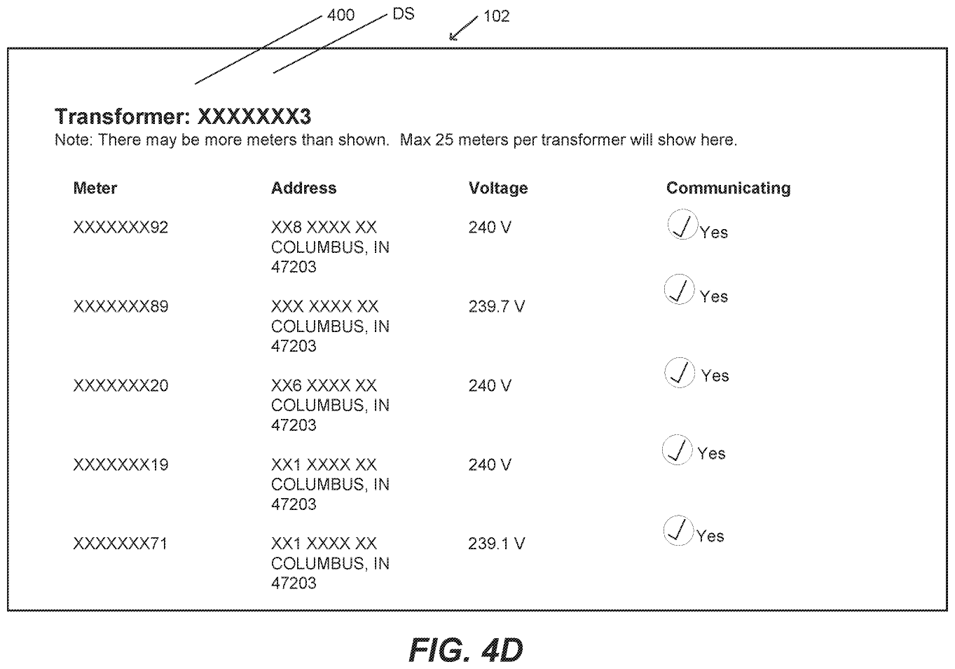

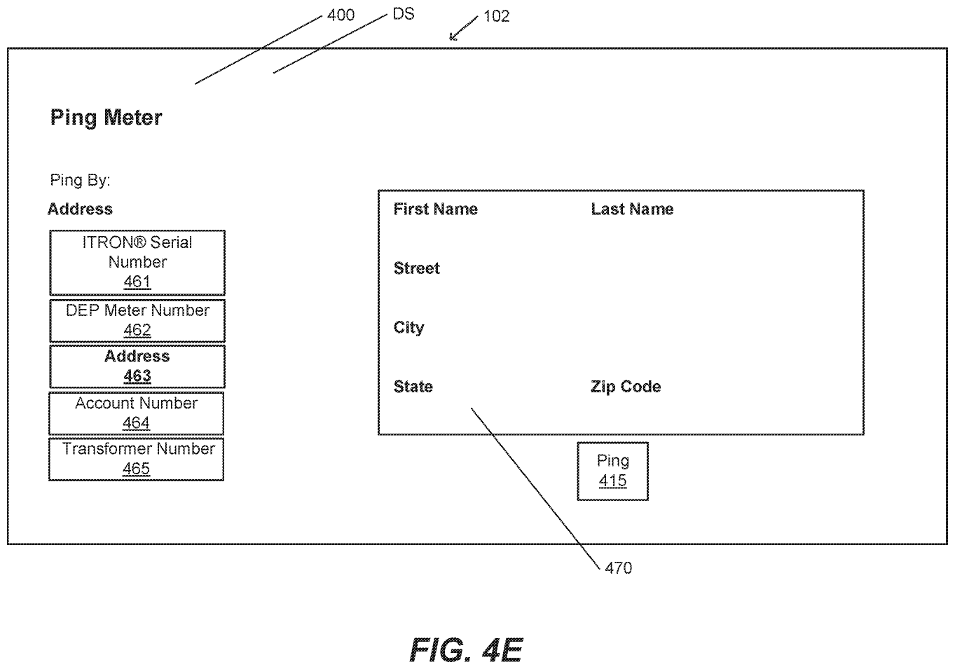

As an example, referring to FIG. 3B, the receiving (Block 305) operations of FIG. 3A may include receiving (Block 305-A), via a GUI, a first user input that includes a meter identifier of the meter 110 (or a transformer identifier of the transformer). The meter identifier may be a meter number, such as an ITRON® serial number or meter number. In some embodiments, the ping is transmitted (Block 310) in response to a second user input that is received (Block 305-D) via the GUI after receiving (Block 305-A) the first user input. For example, the user 101 may provide the first user input by typing a meter number and may then provide the second user input by selecting a ping button 415 (FIG. 4A) in the GUI. Accordingly, the second user input may comprise a command to transmit (Block 310) the ping. Moreover, in some embodiments, the first user input may comprise an indication of the type/category of data that the user 101 would like to retrieve from the meter 110 (or the transformer).

The first and second user inputs may, in some embodiments, be user inputs to a website that is behind a firewall of an electric utility. This may protect against unauthorized use of the website to communicate with the meter 110 (or the transformer). Additionally or alternatively, operation(s) of accessing (Block 300) the website/application may include entry of a user name and password into the website/application before enabling the user 101 to transmit (Block 310) the ping, thus enhancing security. Moreover, in some embodiments, operation(s) of accessing (Block 300) the website/application may include accessing a website via a custom web browser of an electric utility. For example, use of the website/application may require that the user 101 (a) is using a particular browser, such as the custom web browser of the electric utility, on a smartphone (e.g., the electronic device 102) that is issued by the electric utility or (b) is on a network, such as the LAN 135 (FIG. 1B), of the electric utility.

One or more operations of receiving (Block 305) user input(s) may be performed after operation(s) of displaying (Block 330) an indication of an electrical parameter measured by the meter 110. For example, FIG. 3B illustrates receiving (Block 305-E), via the GUI, a third user input to re-ping the meter 110 (or the transformer) or to delete the meter 110 from a list of pinged meters 110, after displaying (Block 330) the indication of the electrical parameter.

Before or after receiving (Block 320) the meter data and displaying (Block 330) the indication of the electrical parameter, a user 101 of the electronic device 102 may transmit (Block 310) a ping to another meter 110 (or another transformer). As an example, the user 101 may provide another meter number as a user input (Block 305) while awaiting the results of a ping. In some embodiments, a group of meter numbers may be simultaneously provided as user input(s) (Block 305) at the electronic device 102, which may result in simultaneously transmitting (Block 310) a plurality of pings to a plurality of meters 110 (or a plurality of transformers), respectively. This may be beneficial during, for example, storm clean-up to verify power restoration to a group of customer premises 120 (FIG. 1A).

Referring still to FIG. 3B, operations at the electronic device 102 may include displaying (Block 305-C), via the GUI, an indication of an error. For example, the error may occur in response to a user input (e.g., the first user input of Block 305-A), via the GUI, that includes (a) an invalid meter (or transformer) number or (b) a meter number of a non-AMI meter (Block 305-B). In some embodiments, a job status for the meter 110 may be indicated as “Error” in a meter list 420 (FIGS. 4A and 4B), as a result of the error.

Referring to FIG. 3C, the transmitting (Block 310) and receiving (Block 320) operations of FIG. 3A may be performed concurrently with a telephone or web-based communication session between the user 101 and an electric utility customer who is associated with the meter 110. Accordingly, the transmitting (Block 310) operation(s) may include transmitting (Block 310C) the ping to the meter 110 (or the transformer) via the cellular/mesh network, concurrently with the telephone or web-based communication session with the customer. For example, the user 101 may be a utility employee, and the meter ping can be transmitted by the utility employee via the electronic device 102 while the utility employee is in a telephone or web-based communication with the customer. Similarly, the receiving (Block 320) operation(s) may include receiving (Block 320C) the meter data from the meter 110 (or the transformer) via the cellular/mesh network, concurrently with the telephone or web-based communication session with the customer. In some embodiments, the telephone or web-based communication session may be performed via the electronic device 102.

Additionally or alternatively, the electronic device 102 may be communicatively coupled to a LAN of an electric utility, such as the LAN 135 (FIG. 1B), and the transmitting (Block 310) and receiving (Block 320) operations may include transmitting the ping via the LAN to the cellular/mesh network and receiving the meter data via the LAN from the cellular/mesh network. Moreover, the transmitting (Block 310) and receiving (Block 320) operations may, in some embodiments, be performed before or after (or even in lieu of), rather than concurrently with, the telephone or web-based communication session between the user 101 and the customer.

Referring to FIG. 3D, operation(s) of displaying (Block 330) the indication of the electrical parameter may include displaying (Block 330-A), via the GUI, an indication of a voltage that is measured by the meter 110. For example, the indication of the voltage may include an indication that the voltage is present on a customer side of the meter 110. Additionally or alternatively, the indication of the voltage may include a numerical value of an average voltage measured by the meter 110. In some embodiments, the indication of the voltage may also include an indication to the user 101 of whether the voltage value provided by the meter 110 (or the transformer) is within the expected voltage range for that meter 110. Moreover, the electronic device 102 may further display (Block 330-C), via the GUI, real-time data in response to receiving, via the GUI, a user input (Block 330-B) after displaying (Block 330-A) the indication of the voltage. The meter data that is received (Block 320) from the meter 110 (or the transformer) may comprise the real-time data, which may include (i) an instantaneous voltage measured by the meter 110, (ii) instantaneous power delivered to a customer premise 120 (FIG. 1A), (iii) instantaneous power received from the customer premise 120, (iv) accumulated power delivered to the customer premise 120, and/or (v) accumulated power received from the customer premise 120.

Referring to FIG. 3E, operation(s) of displaying (Block 330) the indication of the electrical parameter may include displaying (Block 330S) both (a) the indication of the electrical parameter and (b) an indication of a connection status of a switch 220 (FIG. 2B) of the meter 110. For example, the indication may show whether the meter 110 is connected or disconnected. Accordingly, the user 101 can see both whether the meter 110 is connected and whether it has power. This may aid the user 101's understanding of a reported outage at a customer premise 120 (FIG. 1A) because the meter 110 may, in some instances, have power but be disconnected (i.e., the switch 220 may be open) due to the customer's failure to pay a utility bill. Accordingly, seeing the connection status can help an electric utility to reduce occurrences of unnecessarily sending utility trucks to customers. In some embodiments, the user 101 may operate the electronic device 102 to transmit (Block 340), via/using the cellular/mesh network, a command that remotely controls the switch 220 to connect or disconnect the meter 110, in response to receiving (Block 335) a user input via the GUI.

Referring to FIG. 3F, the electronic device 102 may receive (Block 305U), via the cellular/mesh network, an unsolicited indication from the meter 110 (or the transformer or another electric utility meter 110) that the meter 110 (or the transformer or the other meter 110) is experiencing a power outage. For example, in some cases, the indication of the power outage may result from meter tampering, such as a meter swap or meter theft.

FIGS. 4A to 4E are screenshots of a GUI 400 of an electronic device 102 (FIGS. 1B, 1C, and 2A) that is configured to communicate with an electric utility meter 110 (FIGS. 1A and 2B) or a transformer, according to embodiments of the present inventive concepts. Referring to FIG. 4A, the GUI 400 may be a GUI that is displayed on a display screen DS (FIG. 2A) of the electronic device 102. A user 101 (FIGS. 1B and 1C) may enter (e.g., type) a meter number, which identifies the meter 110, in a text box 410. After entering the meter number, the user 101 may select a ping button 415 to transmit a ping to the meter 110 that is identified by the meter number. The meter number and the selection of the ping button 415 may be the first user input (Block 305-A) and the second user input (Block 305-D), respectively, of FIG. 3B. Before selecting the ping button 415, the user 101 may specify data that the ping will request of the meter 110. For example, the GUI 400 may include boxes that the user 101 can select (e.g., check) to request various data. In some embodiments, the data may include (i) communication status of the meter 110, (ii) load side data for the meter 110, (iii) line side data for the meter 110, (iv) connection status of the meter 110, and/or (v) real-time data measured by the meter 110.

In the example of FIG. 4A, the user 101 has selected a communication status box 413-C with a check mark. As a result, the GUI 400 includes a communication status indicator 413. In this example, the communication status is indicated as “Yes,” which means that the meter 110 is presently capable of communicating with the electronic device 102 as of a given time (e.g., 12:15 PM). If, on the other hand, the meter 110 cannot presently respond to the ping from the electronic device 102, then the communication status may be indicated as “No.”

The user 101 in the example of FIG. 4A has also selected load side data for the meter 110, line side data for the meter 110, connection status of the meter 110, and real-time data measured by the meter 110. Accordingly, the GUI 400 includes a load side indicator 414 for the meter 110, line side data 412 for the meter 110, a connection status indicator 411 of the meter 110, and real-time data 450 (FIG. 4B) measured by the meter 110. The load side indicator 414 includes an indication of whether a voltage is present on the customer's side of the meter 110. For example, the indication may be “Present” or “Not Present.” The connection status indicator 411 may indicate whether a disconnect switch, such as a switch 220 (FIG. 2B) of the meter 110 is in a connected state (closed) or a disconnected state (open). The connection status indicator 411 can also indicate that a meter does not have a disconnect switch, such as in the case of a commercial meter, by stating the meter 110 is not disconnect capable (i.e., power cannot be disconnected remotely).

Moreover, the line side data 412 may indicate a numerical average voltage measured by the meter 110 over a given timeframe (e.g., 5 minutes), as well as minimum and maximum voltages during that timeframe. In some embodiments, the GUI 400 may also display a list 440 of features that the user 101 may select via the GUI 400. For example, the user 101 can select the item “Phase Angle Data” from the list 440 to receive information about how to use the GUI 400 to display phase angle data. Additionally or alternatively, the GUI 400 may include one or more information icons, such as a load side information icon 414-I, which the user 101 can select to receive additional information and a description of a measurement result.

In some embodiments, the GUI 400 may include a meter list 420 that indicates meters 110 that the user 101 has pinged. The user 101 can select a clear page button 421 to clear the list 420, which list 420 may indicate average voltages for respective meters 110 that have been pinged. The user 101 can also select an action button 422 for an individual meter 110 on the list 420. Actions available to the user 101 may include deleting the individual meter 110 from the list 420 or re-pinging the individual meter 110.

In some embodiments, the operations of FIGS. 3A-3F may be performed via a software application, and the user 101 may use a message center 430 of the GUI 400 to communicate errors or messages (e.g., downtime for the application) to one or more users of the application. For example, the user 101 may type a message in the message center 430 to globally send the message to all users of the application. Moreover, the user 101 may type a message in the message center 430 to send a text message, such as a Short Message Service (SMS) message or a Multimedia Messaging Service (MMS) message, to one or more customers via a cellular wireless network.

Referring to FIG. 4B, the user 101 may toggle between showing real-time data 450 and the data that is provided in FIG. 4A, including the load side indicator 414, communication status indicator 413, line side data 412, and connection status indicator 411, by selecting a button 416 or a button 417. The real-time data 450 may include an instant voltage, which may be a real-time voltage measurement by the meter 110. The real-time data 450 may also include measurements by the meter 110 of power delivered to, and/or received from, a customer premise 120 (FIG. 1A). For example, the real-time data 450 may include an instantaneous read of real-time power (e.g., in Watts) delivered to the customer premise 120 and/or an instantaneous read of real-time power received from the customer premise 120. Additionally or alternatively, the real-time data 450 may include a registered read of accumulated power (e.g., in kilowatt hours (kWh)) delivered to the customer premise 120 and/or a registered read of accumulated power received from the customer premise 120. The registered read of accumulated power delivered to the customer premise 120 may also be referred to herein as a “meter read.” Moreover, the user 101 may access additional information regarding the real-time data 450 by selecting an information icon 450-I via the GUI 400.

In some embodiments, the user 101 may access customer account data via the GUI 400. For example, after typing a meter number in the text box 410, the GUI 400 may automatically display customer account data for a customer whose meter 110 is associated with the meter number. Alternatively, the GUI 400 may present the user 101 with a user-selectable option to view the customer account data in response to entry by the user 101 of the meter number in the text box 410. The customer account data may include, for example, a customer's name, mailing address, phone number, email address, and/or account payment status (e.g., current or delinquent).

Referring to FIG. 4C, the user 101 may select account details for a particular customer via the GUI 400. For example, the user 101 may select an account-details button (or tab) 418 via the GUI 400 to display the account details. The account details may include information about the customer such as (i) account number, (ii) account status (e.g., active, delinquent, or suspended), (iii) active date, (iv) normal circuit ID, (v) operations center, (vi) account conditions, (vii) customer name, (viii) primary phone number, (ix) alternate phone number, (x) mailing address, and/or (xi) premise address.

In some embodiments, the account details may be displayed after pinging a meter 110. Accordingly, the GUI 400 may simultaneously display the account details along with a meter number and a last read time/date of the meter 110. The last read time/date indicates the most recent time/date that the meter 110 was read into/by a meter database.

Upon quickly resolving an issue with respect to the meter 110, the user 101 can select an avoid-outage-ticket button 419 via the GUI 400 to indicate that the issue was resolved without creating an outage ticket. The GUI 400 thereby allows the user 101 to report the avoidance of outage tickets.

Referring to FIG. 4D, the user 101 can ping a transformer (e.g., a distribution transformer DT (FIG. 1A)) that is coupled to multiple meters 101. As a result, the GUI 400 can display information such as (i) meter number, (ii) premise address, (iii) measured voltage, and/or (iv) communication status (e.g., communicating vs. not communicating) for several of the meters 110 that are coupled to the transformer. In particular, the transformer may be coupled between the meters 110 and a substation 140 (FIG. 1A), to step down a voltage level provided by the substation 140 to a lower voltage level that is usable at customer premises 120 (FIG. 1A).

Referring to FIG. 4E, the GUI 400 may present the user 101 with several pinging options. For example, the user 101 can ping a meter 110 (or a transformer) by (i) ITRON® serial number, (ii) DEP meter number, (iii) premise address, (iv) customer account number, and/or (v) transformer number. Accordingly, the user 101 may have at least five different ways to ping the meter 110 (or transformer). In some embodiments, the user 101 can use one of corresponding buttons (or tabs) 461-465 in the GUI 400 to select a way to ping. Moreover, the GUI 400 may include a drop-down list that presents the pinging options to the user 101.

In FIG. 4E, an example is shown in which the user 101 has selected the option to ping by premise address, which can be entered by the user 101 via a text box 470 of the GUI 400. In some embodiments, after the user 101 inputs information identifying the meter 110 (or transformer) to be pinged, the user 101 may then select a ping button 415 via the GUI 400 to ping the identified meter 110 (or transformer).

FIGS. 4A-4C illustrate examples of information that can result from pinging a meter 110, and FIG. 4D illustrates an example of information that can result from pinging a transformer. Some components that are illustrated herein with respect to the meter 110 may be included in the transformer. For example, the transformer may include a processor P (FIG. 2B), a memory M (FIG. 2B), and network interface(s) N (FIG. 2B), and thus may receive meter data from multiple meters 110 and report the meter data to an electronic device 102 (FIG. 2A), such as a device that pings the transformer. As an example, the transformer may use its processor P to differentiate between meter data from different meters 110, and to report the meter data in response to a ping.

The user 101 may be an electric utility employee or contractor who is authorized to access data from meters 110 and transformers. Alternatively, the user 101 may be a customer of the electric utility. For example, though the customer may not be authorized to access transformer data or data regarding other customers' meters 110, the customer may, in some embodiments, be authorized to use the GUI 400 to ping the customer's meter 110.

Methods of operating an electronic device 102 according to embodiments of the present inventive concepts may provide a number of advantages. These advantages include significantly faster response times to pings of meters 110. For example, the use of a fast, reliable cellular network (e.g., 4G, 5G, LTE, other fast cellular) or RF mesh network may facilitate rapid response times. Moreover, the rapid response times may facilitate the receipt of a wide range of data, including real-time data, from the meter 110 at the electronic device 102.

The electronic device 102 may perform any of the operations of FIGS. 3A-3F from, for example, (i) a control room for a grid 100 (FIG. 1A), (ii) an engineering office, (iii) a customer support call center, (iv) a revenue services office, or (v) the field (FIG. 1C). For example, referring to the room 134 illustrated in FIG. 1B, a DCC may use the operations for support in closing outage tickets and reducing truck rolls/deployment. As another example of the room 134, a customer care center may use the operations to support customer outage phone calls or power quality phone calls. Moreover, after a weather storm, it may be helpful to ping meters 110 during storm clean-up to verify power restoration. In some embodiments, the operations of FIGS. 3A-3F may be performed in one or more utility company software applications, such as via an Application Programming Interface (API), on the electronic device 102.

The advantages of the present inventive concepts may also include an improved customer experience. For example, a customer may report an outage without knowing that the issue is simply a matter of a flipped/tripped breaker. Conventionally, a utility truck may be sent to the customer, which may take hours of time. Using the present inventive concepts, however, an electric utility can ping the meter 110 and identify that the customer has positive voltage, and thus that the meter 110 has power. Accordingly, the electric utility can remotely notify the customer to flip the breaker to solve the problem, thus solving the problem in minutes rather than hours.

The present inventive concepts have been described above with reference to the accompanying drawings. The present inventive concepts are not limited to the illustrated embodiments. Rather, these embodiments are intended to fully and completely disclose the present inventive concepts to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

It will also be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of present inventive concepts.

Example embodiments of the present inventive concepts may be embodied as nodes, devices, apparatuses, and methods. Accordingly, example embodiments of present inventive concepts may be embodied in hardware and/or in software (including firmware, resident software, micro-code, etc.). Furthermore, example embodiments of present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Example embodiments of present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create/use circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

That which is claimed is:

1. A method of operating an electronic device to communicate with an electric utility meter or a transformer, the method comprising:
transmitting, via a cellular network and/or an unlicensed frequency band of a wireless mesh network, a ping from the electronic device to the electric utility meter or the transformer;
receiving, via the cellular network and/or the unlicensed frequency band of the wireless mesh network, meter data from the electric utility meter or the transformer at the electronic device, in response to the ping; and
displaying, via a Graphical User Interface (GUI) of the electronic device, an indication of a voltage measured by the electric utility meter, in response to receiving the meter data.

2. The method of claim 1, wherein displaying the indication of the voltage comprises:
displaying an indication that the voltage is present on a customer side of the electric utility meter.

3. The method of claim 1, wherein displaying the indication of the voltage comprises:
displaying a numerical value of an average voltage measured by the electric utility meter.

4. The method of claim 1, further comprising:
receiving, via the GUI, a first user input comprising a meter identifier of the electric utility meter or a transformer identifier of the transformer,
wherein transmitting the ping is performed in response to a second user input that is received via the GUI after receiving the first user input.

5. The method of claim 4, wherein the first and second user inputs comprise user inputs to a website that is behind a firewall of an electric utility.

6. The method of claim 5, further comprising:
accessing the website via a custom web browser of the electric utility.

7. The method of claim 5, further comprising:
receiving, via the GUI, a third user input to re-ping the electric utility meter or to delete the electric utility meter from a list of pinged electric utility meters, after displaying the indication of the voltage.

8. The method of claim 7, wherein the list of the pinged electric utility meters comprises respective indications of average voltage measured by the pinged electric utility meters.

9. The method of claim 1, wherein transmitting the ping and receiving the meter data are performed concurrently with a telephone or web-based communication session between a user of the electronic device and an electric utility customer who is associated with the electric utility meter.

10. The method of claim 1, wherein the unlicensed frequency band of the wireless mesh network comprises 900 Megahertz (MHz).

11. The method of claim 1, wherein the electric utility meter comprises an Advanced Metering Infrastructure (AMI) meter.

12. The method of claim 11, further comprising:
displaying, via the GUI, an indication of an error in response to a user input, via the GUI, that comprises:
an invalid meter number; or
a meter number of a non-AMI meter.

13. The method of claim 1, wherein the meter data comprises real-time data comprising:
an instantaneous voltage measured by the electric utility meter;
instantaneous power delivered to a customer premise that is connected to the electric utility meter;
instantaneous power received from the customer premise;
accumulated power delivered to the customer premise; and
accumulated power received from the customer premise.

14. The method of claim 13, further comprising:
displaying, via the GUI, the real-time data, in response to a user input after displaying the indication of the voltage.

15. The method of claim 1, further comprising:
displaying, via the GUI, an indication of a connection status of a switch of the electric utility meter.

16. The method of claim 15, further comprising:
transmitting, via the cellular network and/or the unlicensed frequency band of the wireless mesh network, a command that remotely controls the switch to connect or disconnect the electric utility meter, in response to a user input via the GUI.

17. The method of claim 1, further comprising:
receiving, via the cellular network and/or the unlicensed frequency band of the wireless mesh network, an unsolicited indication from another electric utility meter that the other electric utility meter is experiencing a power outage.

18. The method of claim 1,
wherein transmitting the ping comprises transmitting the ping via a Local Area Network (LAN) of an electric utility to the cellular network or the wireless mesh network, and
wherein receiving the meter data comprises receiving the meter data via the LAN from the cellular network or the wireless mesh network.

19. The method of claim 1,
wherein transmitting the ping comprises:
transmitting, via the cellular network, the ping from the electronic device to a gateway device that is in the field; then
transmitting, via the unlicensed frequency band, the ping from the gateway device to the electric utility meter or the transformer, and
wherein receiving the meter data comprises:
receiving, via the unlicensed frequency band, the meter data from the electric utility meter or the transformer at the gateway device; then
receiving, via the cellular network, the meter data from the gateway device at the electronic device.

20. An electronic device comprising:
a display screen;
a network interface;
a processor; and
a storage medium coupled to the processor and comprising computer readable program code that when executed by the processor causes the processor to perform operations comprising:
transmitting, via a cellular network and/or an unlicensed frequency band of a wireless mesh network, a ping from the electronic device to an electric utility meter or a transformer;
receiving, via the cellular network and/or the unlicensed frequency band of the wireless mesh network, meter data from the electric utility meter or the transformer at the electronic device, in response to the ping; and
displaying, via the display screen, an indication of a voltage measured by the electric utility meter, in response to receiving the meter data.

21. The electronic device of claim 20,
wherein the network interface is configured to connect the electronic device to a Local Area Network (LAN) of an electric utility,
wherein transmitting the ping comprises using the network interface to transmit the ping via the LAN to the cellular network or the wireless mesh network, and
wherein receiving the meter data comprises using the network interface to receive the meter data via the LAN from the cellular network or the wireless mesh network.

22. A computer program product comprising:
a non-transitory computer readable storage medium comprising computer readable program code therein that when executed by a processor causes the processor to perform operations comprising:
transmitting, via a cellular network and/or an unlicensed frequency band of a wireless mesh network, a ping from an electronic device to an electric utility meter or a transformer;
receiving, via the cellular network and/or the unlicensed frequency band of the wireless mesh network, meter data from the electric utility meter or the transformer at the electronic device, in response to the ping; and
displaying, via a Graphical User Interface (GUI) of the electronic device, an indication of an electrical parameter measured by the electric utility meter, in response to receiving the meter data.

23. The computer program product of claim 22, wherein displaying the indication of the electrical parameter comprises:
displaying an indication that a voltage is present on a customer side of the electric utility meter; and/or
displaying a numerical value of an average voltage measured by the electric utility meter.
